(19) United States
(12) Patent Application Publication
(10) Pub. No.: US 2022/0352926 A1
(43) Pub. Date: Nov. 3, 2022

(54) MANAGEMENT APPARATUS, MANAGEMENT METHOD, AND PROGRAM

(71) Applicant: HONDA MOTOR CO., LTD., Tokyo (JP)

(72) Inventors: Shota Yamaguchi, Wako-shi (JP); Ryoji Iida, Wako-shi (JP); Marika Mochizuki, Wako-shi (JP)

(21) Appl. No.: 17/713,252

(22) Filed: Apr. 5, 2022

(30) Foreign Application Priority Data
Apr. 28, 2021 (JP) 2021-076531

(51) Int. Cl. H04B 5/00

(52) U.S. Cl. CPC H04B 5/0037

(57) ABSTRACT

A management apparatus includes a supply reception part, a supply transmission part, and a request reception part. The supply reception part receives, from a supplier terminal of a supplier who owns an electric power device capable of performing an electric power supply, electric power supply data which includes available information representing an available electric power amount and a position of the electric power device. The supply transmission part transmits the electric power supply data to a consumer terminal of a consumer who desires an electric power supply. The request reception part receives request data indicating a request of an electric power supply according to the electric power supply data from the consumer terminal.

### CROSS-REFERENCE TO RELATED APPLICATION

Priority is claimed on Japanese Patent Application No. 2021-076531, filed on Apr. 28, 2021, the contents of which are incorporated herein by reference.

### BACKGROUND

### Field of the Invention

The present invention relates to a management apparatus, a management method, and a program.

### Background

Japanese Unexamined Patent Application, First Publication No. 2011-248787 discloses a technique for displaying on a map the position of a rapid charging stand including a private rapid charging stand. In this way, by providing information on a private electric power device, it is possible to increase options presented to a consumer who desires electric power supply.

### SUMMARY

However, an electric power device capable of supplying electric power is not always available. For example, the supplier may plan to use the electric power device for another application. Further, for example, in a case where the amount of electric power which the electric power device is capable of supplying is limited, a sufficient amount of electric power may not remain.

An object of an aspect of the present invention is to provide a management apparatus, a management method, and a program capable of providing information of an available electric power device.

A management apparatus according to a first aspect of the present invention includes: a supply reception part that receives, from a supplier terminal of a supplier who owns an electric power device capable of performing an electric power supply, electric power supply data which includes available information representing an available electric power amount and a position of the electric power device; a supply transmission part that transmits the electric power supply data to a consumer terminal of a consumer who desires an electric power supply; and a request reception part that receives request data indicating a request of an electric power supply according to the electric power supply data from the consumer terminal.

A second aspect is the management apparatus according to the first aspect which may include: a request transmission part that transmits the request data to the supplier terminal; an approval reception part that receives approval data indicating an approval for the request data from the supplier terminal; and an approval transmission part that transmits the approval data to the consumer terminal, wherein the request data may include information of a planned use amount of the electric power device.

A third aspect is the management apparatus according to the second aspect which may include a graph transmission part that transmits, to the supplier terminal, display data for displaying a graph in which an electric power consumption amount of the electric power device based on the request data and an electric power consumption amount that has been reserved of the electric power device by the supplier are integrated.

A fourth aspect is the management apparatus according to the second or third aspect, wherein the approval transmission part may notify the consumer terminal of authentication data used for an authentication process when the consumer uses the electric power device together with the approval data, and the electric power device may start an electric power supply in a case where an authentication process based on input authentication data succeeds.

A fifth aspect is the management apparatus according to any of the first to fourth aspects which may include: an actual achievement reception part that receives actual achievement data on an electric power supply by the electric power device from the consumer terminal or the supplier terminal, wherein the consumer terminal or the supplier terminal may receive, from the electric power device, the actual achievement data according to an electric power supply to an electrical device of the consumer by the electric power device and transmit the actual achievement data to the management apparatus.

A sixth aspect of the present invention is a management method, by way of a computer, including: receiving, from a supplier terminal of a supplier who owns an electric power device capable of performing an electric power supply, electric power supply data which includes available information representing an available electric power amount and a position of the electric power device; transmitting the electric power supply data to a consumer terminal of a consumer who desires an electric power supply; and receiving a request of an electric power supply according to the electric power supply data from the consumer terminal.

A seventh aspect of the present invention is a computer-readable non-transitory storage medium which includes a program causing a computer to function as: an information reception part that receives, from a supplier terminal of a supplier who owns an electric power device capable of performing an electric power supply, electric power supply data which includes available information representing an available electric power amount and a position of the electric power device; an information transmission part that transmits the electric power supply data to a consumer terminal of a consumer who desires an electric power supply; and a request reception part that receives a request of an electric power supply according to the electric power supply data from the consumer terminal.

According to at least any of the first to seventh aspects described above, it is possible to provide information of an available electric power device.

### BRIEF DESCRIPTION OF THE DRAWINGS

FIG. 1 is a schematic view showing a configuration of an electric power sharing system according to a first embodiment.

FIG. 2 is a sequence view showing an operation example of the electric power sharing system according to the first embodiment.

FIG. 3 is a view showing an example of an input screen of electric power supply data according to the first embodiment.

FIG. 4 is a view showing an example of an electric source map according to the first embodiment.

FIG. 5 is a view showing an example of a selection screen according to the first embodiment.

FIG. 6 is a view showing an example of a reservation screen according to the first embodiment.

FIG. 7 is a view showing an example of an acceptance screen according to the first embodiment.

FIG. 8 is a schematic block view showing a configuration of a management apparatus according to the first embodiment.

FIG. 9 is a schematic block view showing a configuration of an electric power device according to the first embodiment.

FIG. 10 is a schematic block view showing a configuration of a computer according to at least one embodiment.

### DESCRIPTION OF EMBODIMENTS

### First Embodiment

### <<Configuration of Electric Power Sharing System>>

Hereinafter, embodiments will be described in detail with reference to the drawings.

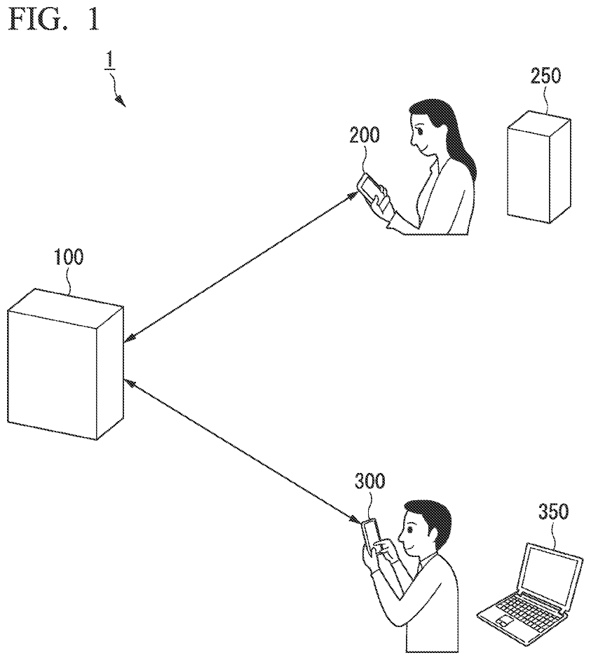

FIG. 1 is a schematic view showing a configuration of an electric power sharing system 1 according to a first embodiment.

The electric power sharing system 1 is a system that presents an available electric power device 250 including a private electric power device 250 to a consumer and mediates electric power transactions. In the present embodiment, a person who has a demand for electric power is referred to as a consumer. Further, a person who supplies electric power, that is, a person who owns an electric power device 250 capable of supplying electric power is referred to as a supplier.

The electric power sharing system 1 includes a management apparatus 100, a supplier terminal 200, an electric power device 250, a consumer terminal 300, and an electrical device 350.

The management apparatus 100 communicates with the supplier terminal 200 and the consumer terminal 300 and manages electric power transactions.

The supplier terminal 200 is a terminal device operated by a supplier who owns the electric power device 250. The electric power device 250 is a device capable of supplying electric power. Examples of the electric power device 250 include an electric source device including a secondary battery and a converter, a generator, and the like. The electric power device 250 is connected to a smart tap having one or more output terminals for supplying electric power. The smart tap has a short-distance wireless communication function, a user authentication function, a supply control function, and a consumed electric power measurement function. The smart tap receives authentication data from a user through a short-distance wireless communication, performs user authentication based on authentication data, starts to supply electric power from an output terminal when authentication is established, measures the amount of supplied electric power, and transmits the measurement result through the short-distance wireless communication. The electric power device 250 may not necessarily be connected to the smart tap and may include a function equivalent to the smart tap. The communication function of the smart tap may not be the short-distance wireless communication, may use a wired communication via a USB cable or the like, and may perform transmission using a memory card.

The consumer terminal 300 is a terminal device operated by a consumer who desires the electric power supply to the electrical device 350. Examples of the electrical device 350 include a notebook PC, a smartphone, a recharger for a secondary battery, an electric vehicle, and the like.

An application program for executing a process according to the electric power sharing system 1 is installed in the supplier terminal 200 and the consumer terminal 300. In other embodiments, the supplier terminal 200 and the consumer terminal 300 may execute a web application supplied by the management apparatus 100 via a web browser.

### <<Operation Example>>

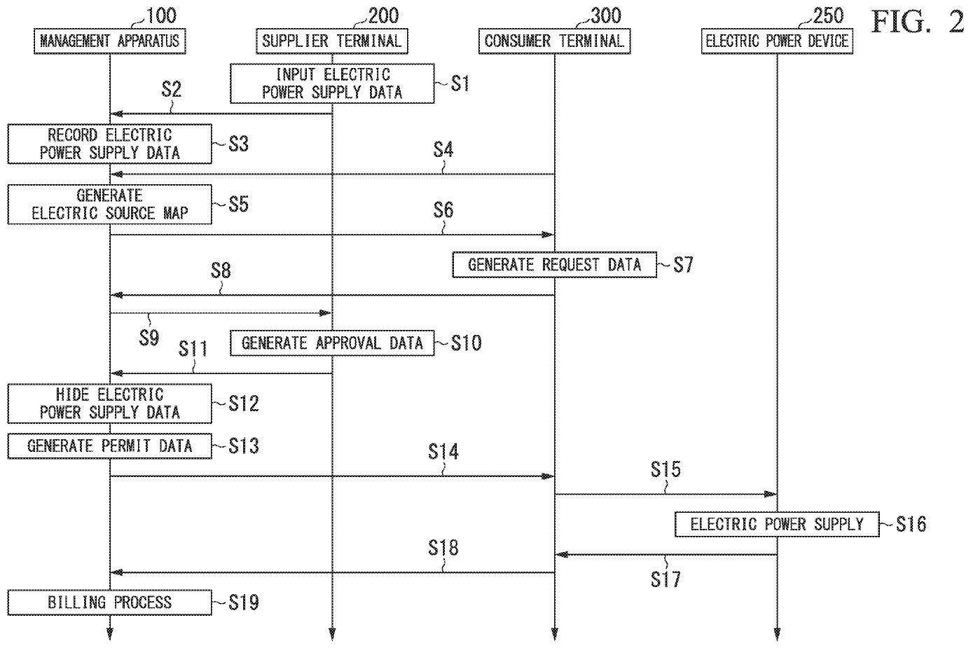

Here, an operation example of the electric power sharing system 1 according to the first embodiment is described. FIG. 2 is a sequence view showing an operation example of the electric power sharing system according to the first embodiment.

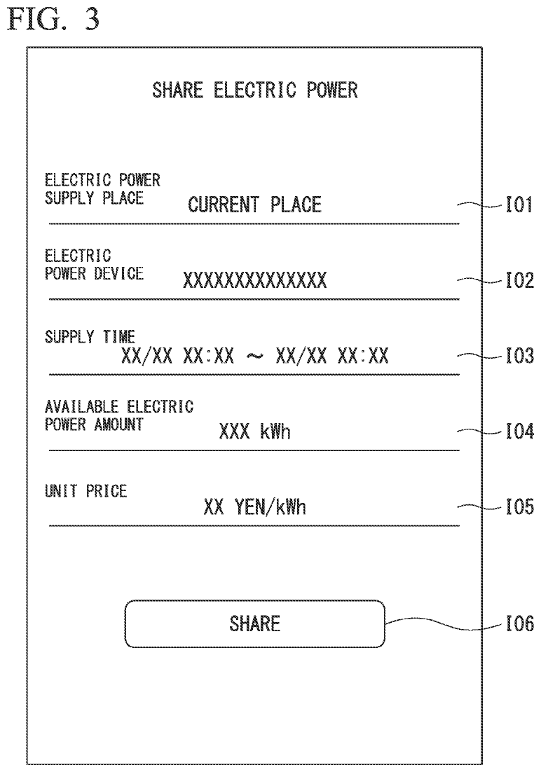

When a supplier wishes to supply electric power of the electric power device 250 to another person, the supplier inputs electric power supply data that includes an electric power supply place, the type of the electric power device 250, the time period when the electric power can be supplied, an electric power amount that can be supplied, and the unit price into the supplier terminal 200 (Step S1). FIG. 3 is a view showing an example of an input screen of the electric power supply data according to the first embodiment. An input field I01 of the electric power supply place, an input field I02 of the type of the electric power device 250, an input field I03 of the time period when the electric power can be supplied, an input field I04 of the electric power amount that can be supplied, an input field I05 of the unit price, and a share button I06 are displayed on the input screen of the electric power supply data. The electric power amount that can be supplied may be automatically calculated from a maximum electric power amount and a consumed electric power amount of the electric power device 250 and may be input as a default value in the input field I04. The electric power sharing system 1 according to the first embodiment receives an input of a numerical value of the electric power amount that can be supplied as available information representing the electric power amount that can be supplied; however, the embodiment is not limited thereto. For example, an electric power sharing system 1 according to another embodiment may receive a selection of classification such as large/medium/small, A/B/C, or the like as the available information. The available information according to another embodiment may represent the electric power amount by designating a target that can be supplied such as a smartphone, a notebook PC, an electric motorcycle, or the like.

When the share button I06 is pressed, the supplier terminal 200 transmits the input electric power supply data to the management apparatus 100 (Step S2). The management apparatus 100 records, in a database, the received electric power supply data in association with the ID of the supplier (Step S3).

When the consumer wishes to receive supply of electric power, the consumer transmits a transmission request of an electric source map to the management apparatus 100 using the consumer terminal 300 (Step S4). When the management apparatus 100 receives the transmission request of the electric source map, the management apparatus 100 generates an electric source map on the basis of the electric power supply data stored in the database (Step S5). The management apparatus 100 transmits the electric source map to the consumer terminal 300 (Step S6).

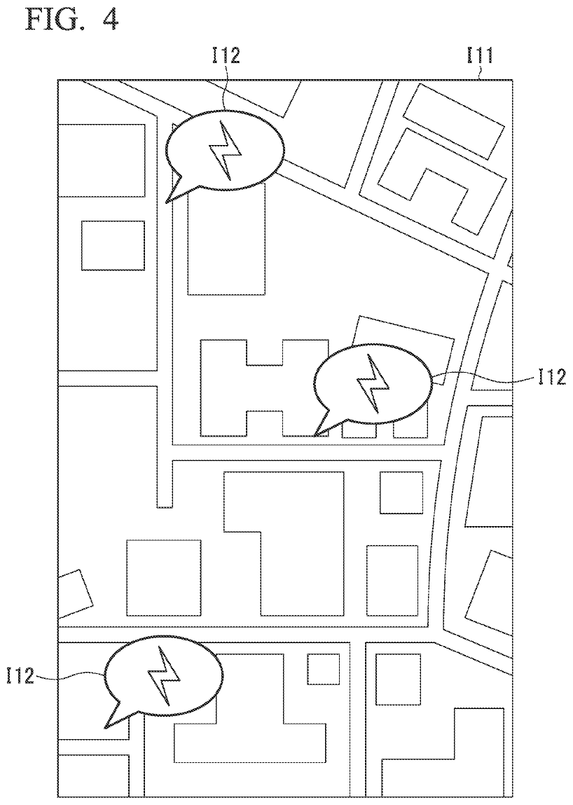

FIG. 4 is a view showing an example of the electric source map according to the first embodiment. The consumer terminal 300 displays the received electric source map on the display. The electric source map includes a map image I11 and an electric source icon I12. The electric source icon I12 points to a position of an available electric power device 250 presented to the consumer.

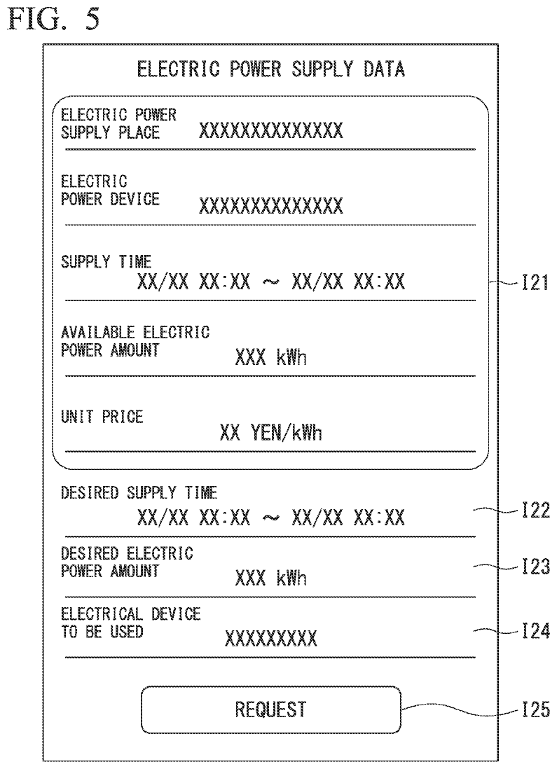

The consumer selects an electric power device 250 from which the consumer wishes to supply electric power on the basis of the information of the electric power device 250 displayed on the electric source map and inputs a desired electric power amount, a use time period, and the type of the electrical device 350. When the electric source icon I12 of the electric source map is selected, the consumer terminal 300 causes the display to display a selection screen that includes electric power supply data indicated by the selected electric source icon I12 and a button which receives selection of whether or not electric power supply from the selected electric power device 250 is desired. FIG. 5 is a view showing an example of a selection screen according to the first embodiment. The selection screen includes a data pane I21 that displays the contents of the electric power supply data, an input field I22 for the desired supply time, an input field I23 for the desired electric power amount, an input field I24 for the type of the electrical device 350, and a request button I25. The desired electric power amount may be automatically calculated by a product of a consumed electric power and a use time of a used electric power device 250. The consumer terminal 300 generates request data that includes the ID of the electric power supply data, the desired electric power amount, and the desired use time period on the basis of the input (Step S7). When the request button I25 is pressed, the consumer terminal 300 transmits the generated request data to the management apparatus 100 (Step S8). The management apparatus 100 pushes the request data received from the consumer terminal 300 to a supplier terminal 200 of a transmission source of the electric power supply data according to the request data (Step S9).

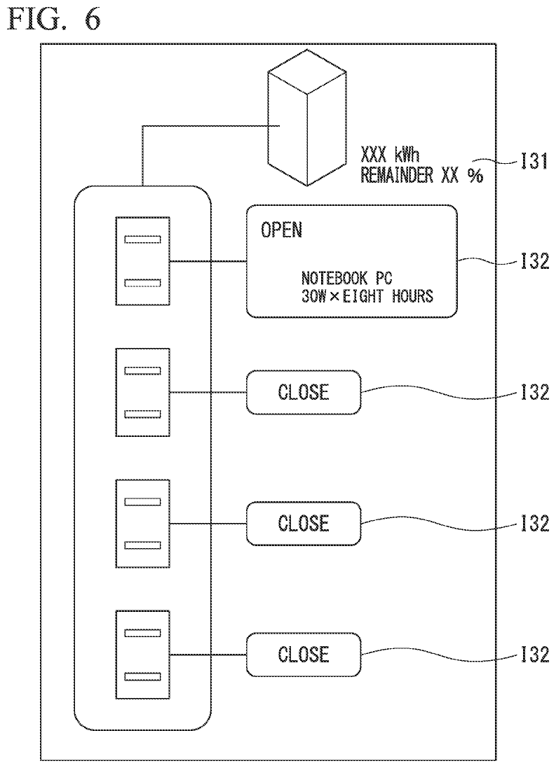

The supplier confirms the request data received by the supplier terminal 200 and determines whether to permit the electric power supply. When permitting the electric power supply, the supplier operates the supplier terminal 200 and generates approval data indicating permission of the electric power supply (Step S10). FIG. 6 is a view showing an example of a reservation screen according to the first embodiment. An SOC display 131 of the electric power device 250 and a status panel 132 of each output terminal of the electric power device 250 are displayed on the reservation screen.

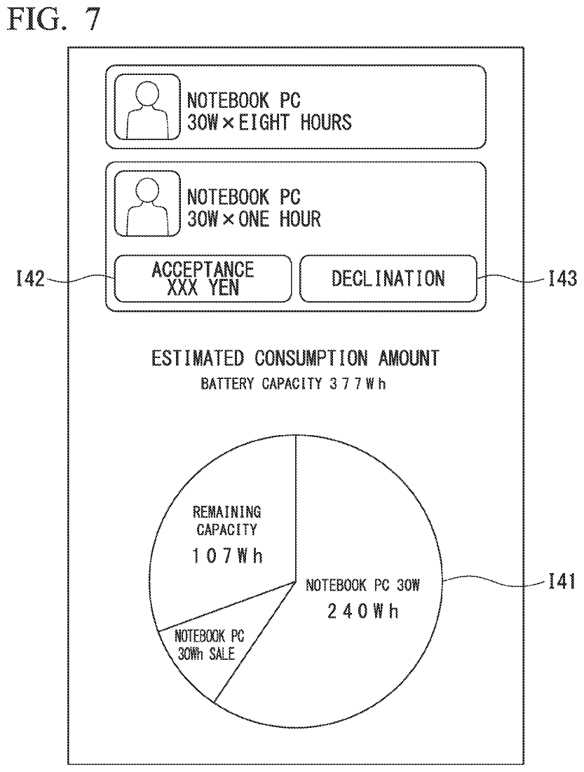

A state “OPEN” or a state “CLOSE” is displayed on the status panel. The electrical device 350 to be connected, the amount to be used, and an icon of the user are displayed on a status panel in which the state is “OPEN”. The user of the electric power device 250 includes not only the consumer but also the supplier himself or herself. When the supplier selects an output terminal in which the state is “CLOSE”, as shown in FIG. 7, the supplier terminal 200 displays an acceptance screen. FIG. 7 is a view showing an example of the acceptance screen according to the first embodiment. A graph I41 indicating the reserved electrical device 350 and electric power consumption amount by the electrical device 350 according to new request data are displayed on the acceptance screen. The electric power consumption amount may be calculated on the basis of the desired electric power amount included in the request data or may be calculated by multiplying a desired supply time by the consumed electric power specified from the type of the used electrical device 350. The reserved electrical device 350 may be an electrical device 350 used by the supplier himself or herself or may be an electrical device 350 according to another request data that has been accepted. The graph I41 represents the ratio of the consumed electric power amount and a remaining capacity of each electrical device 350 relative to the maximum electric power amount of the electrical device 350. An acceptance button 142 for accepting a new request and a declination button 143 for declining the request are displayed on the acceptance screen. By the supplier pressing the acceptance button 142, the supplier terminal 200 generates approval data indicating a use permit of an output terminal selected on the reservation screen. The ID of the request data and the number of an available output terminal are included in the approval data. The supplier terminal 200 transmits the approval data to the management apparatus 100 (Step S11).

When receiving the approved data, the management apparatus 100 updates the database such that the electric power supply data in which the supplier and the consumer are matched with each other is hidden in the electric source map (Step S12). For example, the management apparatus 100 causes an active flag of the electric power supply data according to the approval data to be turned off. The management apparatus 100 generates permit data used for the use of the electric power device 250 (Step S13). The permit data includes the authentication data used for authentication of the electric power device 250, the available time, the available electric power, and the number of the output terminal. The authentication data may be, for example, cryptographic data (signature data in the permit data or the like) that can be verified by key data stored by the electric power device 250. When the authentication data is the cryptographic data, the management apparatus 100 stores the key data (a public key, a shared key, or the like) of each electric power device 250 in advance. Alternatively, the public key of the management apparatus 100 may be stored in the electric power device 250 in advance, and the management apparatus 100 may generate the permit data using an own private key. The management apparatus 100 pushes the permit data to the consumer terminal 300 of the transmission origin of the request data according to the approval data received in Step S11 (Step S14).

The consumer transmits the permit data stored by the consumer terminal 300 to the electric power device 250 through the short-distance communication in a time period of the request (Step S15). The consumer connects the electrical device 350 to the electric power device 250. The electric power device 250 verifies the validity of the permit data and performs the electric power supply in accordance with a condition indicated by the permit data (Step S16). When the electric power supply is completed, the electric power device 250 transmits, to the consumer terminal 300, actual achievement data indicating an actual achievement value of the supplied electric power (Step S17). The consumer terminal 300 causes the display to display the received actual achievement data.

The consumer terminal 300 transmits the received actual achievement data to the management apparatus 100 (Step S18). The management apparatus 100 performs a billing process based on the received actual achievement data (Step S19). That is, the management apparatus 100 performs a charging process to the consumer based on the actual achievement data and performs a payment process to the supplier.

In this way, the electric power sharing system 1 according to the first embodiment can mediate electric power transactions between the consumer and the supplier.

### <<Configuration of Management Apparatus 100>>

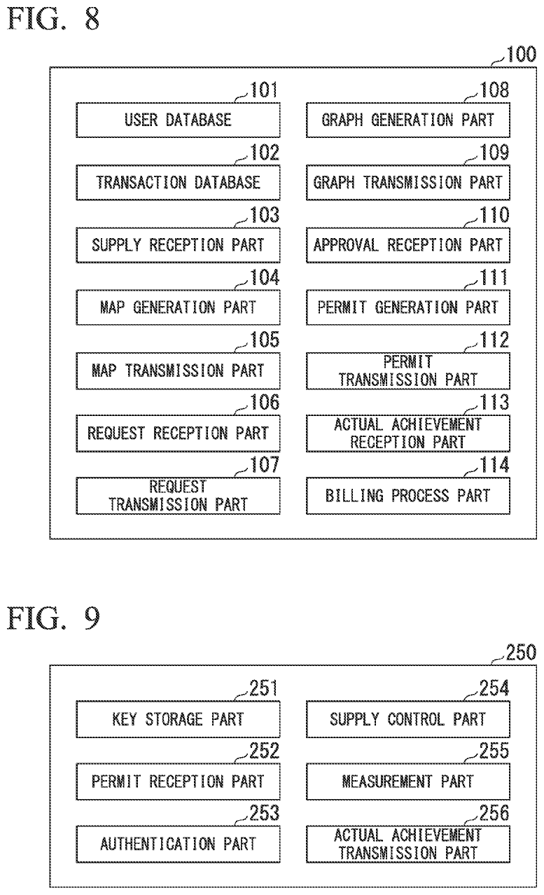

FIG. 8 is a schematic block view showing a configuration of the management apparatus 100 according to the first embodiment.

The management apparatus 100 includes a user database 101, a transaction database 102, a supply reception part 103, a map generation part 104, a map transmission part 105, a request reception part 106, a request transmission part 107, a graph generation part 108, a graph transmission part 109, an approval reception part 110, a permit generation part 111, a permit transmission part 112, an actual achievement reception part 113, and a billing process part 114.

The user database 101 stores information of a user (a supplier and a consumer) of the management apparatus 100. Specifically, the user database 101 stores the ID of the user, the terminal ID (device token), and account data in an associated manner. The terminal ID is used when push notification from the management apparatus 100 to the terminal is performed. The user database 101 stores an electric power device ID, the type of the electric power device 250, and the key data in an associated manner in association with the user ID for each electric power device 250 owned by the user.

The transaction database 102 stores information relating to the electric power supply data received from the supplier terminal 200. The transaction database 102 stores the electric power supply data received from the supplier terminal 200 in association with a unique ID for the electric power supply data, the ID of the supplier, and the active flag. The transaction database 102 stores the request data received from the consumer terminal 300 in association with the ID of the electric power supply data and the ID of the consumer. The transaction database 102 stores the actual achievement data received from the consumer terminal 300 in association with the ID of the electric power supply data and a billing amount.

The supply reception part 103 receives the electric power supply data from the supplier terminal 200. The supply reception part 103 records, in the transaction database 102, the received electric power supply data in association with the ID of the supplier of the reception origin.

The map generation part 104 generates an electric power map on the basis of data in which the active flag is ON among the electric power supply data stored by the transaction database 102.

The map transmission part 105 transmits the electric power map generated by the map generation part 104 to the consumer terminal 300. The map transmission part 105 is an example of a supply transmission part that transmits the electric power supply data to the consumer terminal 300.

The request reception part 106 receives request data from the consumer terminal 300. The request reception part 106 records, in the transaction database 102, the received request data in association with the ID of the electric power supply data that becomes a target and the ID of the consumer.

The request transmission part 107 transmits the request data received by the request reception part 106 to the supplier terminal 200. Specifically, the request transmission part 107 reads the electric power supply data corresponding to the received request data from the transaction database 102 and identifies the supplier of the transmission origin of the electric power supply data. The request transmission part 107 pushes the request data to the supplier terminal 200 associated with the supplier in the user database 101.

The graph generation part 108 generates a graph I41 (FIG. 7) showing an electric power consumption amount of the electric power device 250 when the electric power demand according to the request data is accepted.

The graph transmission part 109 transmits display data for the generated graph I41 to the supplier terminal 200.

The approval reception part 110 receives approval data from the supplier terminal 200. The approval reception part 110 rewrites the active flag of the electric power supply data according to the request data associated with the received approval data to OFF.

The permit generation part 111 generates permit data used for the use of the electric power device 250. For example, the permit generation part 111 generates the permit data according to the following procedure. The permit generation part 111 reads the request data indicated by the approval data from the transaction database 102 and acquires the available time period and the available electric power. The permit generation part 111 generates main body data that includes the acquired available time period, the acquired available electric power, and the number of the output terminal included in the approval data. The permit generation part 111 reads the key data associated with the electric power device 250 that is used with reference to the user database 101. The permit generation part 111 generates authentication data that is signature data by encrypting the hash of the main body data using the read key data. The permit generation part 111 generates a combination of the main body data and the authentication data as the permit data.

The permit transmission part 112 transmits the permit data to the consumer terminal 300 of the transmission origin of the request data according to the approval data.

The actual achievement reception part 113 receives actual achievement data on the electric power supply from the consumer terminal 300. The actual achievement reception part 113 records, in the transaction database 102, the received actual achievement data in association with the electric power supply data.

The billing process part 114 performs a billing process based on the received actual achievement data. The billing process part 114 calculates a billing amount by multiplying a unit price included in the electric power supply data by an electric power amount indicated by the received actual achievement data. Then, the billing process part 114 performs a charging process of the billing amount calculated based on the actual achievement data based on the account data associated with the consumer in the user database 101. The billing process part 114 performs a payment process of the billing amount calculated on the basis of the actual achievement data based on the account data associated with the supplier in the user database 101. The billing process part 114 may determine part of the billing amount as a profit of a provider of the electric power sharing system 1.

FIG. 9 is a schematic block view showing a configuration of the electric power device 250 according to the first embodiment.

The electric power device 250 according to the first embodiment includes a permit reception part 252, an authentication part 253, a supply control part 254, a measurement part 255, an actual achievement transmission part 256, and a key storage part 251.

The key storage part 251 stores the key data.

The permit reception part 252 receives permit data from the consumer terminal 300 through the short-distance wireless communication.

The authentication part 253 verifies the permit data received by the permit reception part 252 by using the key data stored by the key storage part 251. For example, the authentication part 253 decodes the authentication data included in the permit data by the key data and determines whether or not the decoded authentication data matches with the hash of the main body data in the permit data.

The supply control part 254 controls the electric power supply in accordance with the permit data when the permit data is authenticated by the authentication part 253. For example, the supply control part 254 reads the number of the output terminal from the permit data, lights the output terminal according to the number, and thereby clearly specifies the output terminal to which a plug should be inserted to the consumer. The supply control part 254 reads the available time period from the permit data and conducts the output terminal indicated by the permit data when the current time is included in the available time period. The supply control part 254 stops the electric power supply when the electric power amount measured by the measurement part 255 exceeds the available electric power indicated by the permit data. The supply control part 254 stops the electric power supply when the supply control part 254 receives a command to terminate the electric power supply from the consumer terminal 300.

The measurement part 255 measures electric power supplied from the output terminal.

The actual achievement transmission part 256 transmits the actual achievement data indicating electric power measured by the measurement part 255 to the consumer terminal 300 through the short-range wireless communication when the electric power supply is stopped by the supply control part 254. In another embodiment, the actual achievement transmission part 256 may transmit the actual achievement data not to the consumer terminal 300 but to the supplier terminal 200. In this case, even if the supplier leaves before receiving the actual achievement data, the actual achievement data can be transmitted to the management apparatus 100 via the consumer terminal 300.

### <Action and Effect>

In this way, according to the electric power sharing system 1 according to the first embodiment, the management apparatus 100 receives the electric power supply data which includes available information representing the available electric power amount and the position of the electric power device 250 from the supplier terminal 200 and transmits the electric power supply data to the consumer terminal 300.

Then, the management apparatus 100 receives the request data indicating the request of the electric power supply according to the electric power supply data from the consumer terminal 300. Thereby, since the available electric power amount is known from the electric power supply data, and the position of the electric power device 250 is known, it is possible for the consumer to select an appropriate electric power device 250. Further, since the supplier terminal 200 transmits the electric power supply data when the supplier wishes to supply the electric power, the management apparatus 100 can prevent old information from mixing with the supplied electric power supply data.

Further, according to the electric power sharing system 1 according to the first embodiment, the management apparatus 100 transmits the request data including the information of the planned use amount (the desired use time period, the desired electric power amount, and the type of the electrical device 350 to be used by the consumer) of the electric power device 250 from the consumer terminal 300 to the supplier terminal 200 and receives the approval data indicating the approval for the request data from the supplier terminal 200. Then, the management apparatus 100 transmits the received approval data to the consumer terminal 300.

According to the first embodiment, the supplier can appropriately determine whether to permit the supply of electric power on the basis of the planned use amount included in the request data.

Further, according to the electric power sharing system 1 according to the first embodiment, the management apparatus 100 transmits, to the supplier terminal 200, the display data for displaying the graph in which the electric power consumption amount of the electric power device 250 on the basis of the request data and a future use schedule of the electric power device 250 by the supplier are integrated. Thereby, the supplier can visually determine an electric power use situation of the electric power device 250 and can easily determine whether to permit the supply of electric power.

Further, according to the electric power sharing system 1 according to the first embodiment, the management apparatus 100 notifies the consumer terminal of the permit data including the authentication data used for the authentication process. Then, the electric power device 250 starts the electric power supply in a case where the authentication process based on the authentication data that is input from the consumer terminal 300 succeeds. Thereby, the electric power sharing system 1 according to the first embodiment can restrict an unauthorized use of electric power by a third party without the communication between the electric power device 250 and the management apparatus 100. Further, the electric power device 250 according to the first embodiment controls the electric power supply in accordance with the available electric power amount and the available time period included in the permit data.

Thereby, the electric power sharing system 1 can supply electric power within the range of the request approved for the electric power device 250.

Further, according to the electric power sharing system 1 according to the first embodiment, the management apparatus 100 receives the actual achievement data on the electric power supply by the electric power device 250 from the consumer terminal 300. Thereby, the electric power sharing system 1 according to the first embodiment can recognize the actual use of the electric power device 250 without the communication between the electric power device 250 and the management apparatus 100. Further, thereby, the consumer can immediately confirm the used electric power amount after the use of the electric power device 250. Further, in the management apparatus 100, by performing the billing process by using the actual achievement data, the usage fee is calculated on the basis of the actually consumed electric power amount even when the consumed electric power amount of the consumer is less than a planned use amount, and therefore, the consumer does not suffer a loss.

### Other Embodiments

Although one embodiment has been described in detail with reference to the drawings, the specific configuration is not limited to the one described above, and various design changes and the like can be made. That is, in other embodiments, the order of the processes described above may be changed accordingly. Further, some processes may be performed in parallel.

The management apparatus 100 according to the embodiment described above may be constituted of a single computer. The configuration of the management apparatus 100 may be arranged in a plurality of computers separately, and the plurality of computers may cooperate with each other and thereby function as the management apparatus 100.

The management apparatus 100 according to the embodiment described above generates the electric source map including a plurality of electric source icons 112 on the basis of a plurality of electric power supply data recorded in the transaction database 102; however, the embodiment is not limited thereto. For example, the management apparatus 100 according to another embodiment may present, to the consumer terminal 300, only one electric power supply data relating to the location closest to the consumer.

The management apparatus 100 according to the embodiment described above provides information about the electric power supply by a private electric power device 250; however, the embodiment is not limited thereto. For example, the management apparatus 100 according to another embodiment may present information about the electric power supply by a public electric power device 250 such as a charging stand in addition to the private electric power device 250.

In the electric power sharing system 1 according to the embodiment described above, the management apparatus 100 generates the permit data; however, the embodiment is not limited thereto. For example, in the electric power sharing system 1 according to another embodiment, the supplier terminal 200 may store the key data, and the supplier terminal 200 may generate the permit data.

### <Computer Configuration>

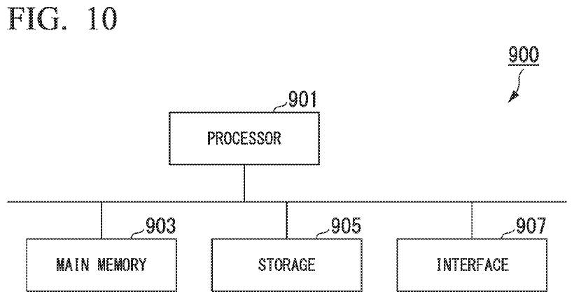

FIG. 10 is a schematic block view showing a configuration of a computer according to at least one embodiment.

A computer 900 includes a processor 901, a main memory 903, a storage 905, and an interface 907.

The management apparatus 100, the supplier terminal 200, the electric power device 250, and the consumer terminal 300 described above are each implemented in the computer 900. The operation of each process part described above is stored in the storage 905 in a form of a program. The processor 901 reads the program from the storage 905, expands the program into the main memory 903, and performs the process described above in accordance with the program. The processor 901 secures a storage area corresponding to each storage part described above in the main memory 903 in accordance with the program. Examples of the processor 901 include a CPU (Central Processing Unit), a GPU (Graphic Processing Unit), a microprocessor, and the like.

The program may be one for implementing part of the function exerted by the computer 900. For example, the program may be one that exerts the function in combination with another program already stored in the storage or in combination with another program implemented in another device. In another embodiment, the computer 900 may include a custom LSI (Large Scale Integrated Circuit) such as a PLD (Programmable Logic Device) in addition to the above configuration or in place of the above configuration. Examples of the PLD include a PAL (Programmable Array Logic), a GAL (Generic Array Logic), a CPLD (Complex Programmable Logic Device), and a FPGA (Field Programmable Gate Array). In this case, some or all of the functions implemented by the processor 901 may be implemented by an integrated circuit. Such an integrated circuit is also included in an example of the processor.

Examples of the storage 905 include a magnetic disk, a magneto-optical disk, an optical disk, a semiconductor memory, and the like. The storage 905 may be internal media directly connected to a bus of the computer 900 or may be external media connected to the computer 900 via the interface 907 or a communication line. In a case where the program is delivered to the computer 900 by the communication line, the computer 900 that receives the delivery of the program may expand the program to the main memory 903 and perform the process described above. In at least one embodiment, the storage 905 is a non-transitory tangible storage medium.

The program may be one for implementing some or all of the functions described above.

Further, the program may be one that realizes the functions described above in combination with another program already stored in the storage 905, that is, a so-called differential file (differential program).

What is claimed is:

1. A management apparatus comprising:
a supply reception part that receives, from a supplier terminal of a supplier who owns an electric power device capable of performing an electric power supply, electric power supply data which includes available information representing an available electric power amount and a position of the electric power device;
a supply transmission part that transmits the electric power supply data to a consumer terminal of a consumer who desires an electric power supply; and
a request reception part that receives request data indicating a request of an electric power supply according to the electric power supply data from the consumer terminal.

2. The management apparatus according to claim 1, comprising:
a request transmission part that transmits the request data to the supplier terminal;
an approval reception part that receives approval data indicating an approval for the request data from the supplier terminal; and
an approval transmission part that transmits the approval data to the consumer terminal,
wherein the request data includes information of a planned use amount of the electric power device.

3. The management apparatus according to claim 2, comprising:
a graph transmission part that transmits, to the supplier terminal, display data for displaying a graph in which an electric power consumption amount of the electric power device based on the request data and an electric power consumption amount that has been reserved of the electric power device are integrated.

4. The management apparatus according to claim 2,
wherein the approval transmission part notifies the consumer terminal of authentication data used for an authentication process when the consumer uses the electric power device together with the approval data, and
the electric power device starts an electric power supply in a case where an authentication process based on input authentication data succeeds.

5. The management apparatus according to claim 1, comprising:
an actual achievement reception part that receives actual achievement data on an electric power supply by the electric power device from the consumer terminal or the supplier terminal,
wherein the consumer terminal or the supplier terminal receives, from the electric power device, the actual achievement data according to an electric power supply to an electrical device of the consumer by the electric power device and transmits the actual achievement data to the management apparatus.

6. A management method, by way of a computer, comprising:
receiving, from a supplier terminal of a supplier who owns an electric power device capable of performing an electric power supply, electric power supply data which includes available information representing an available electric power amount and a position of the electric power device;
transmitting the electric power supply data to a consumer terminal of a consumer who desires an electric power supply; and
receiving a request of an electric power supply according to the electric power supply data from the consumer terminal.

7. A computer-readable non-transitory storage medium which comprises a program causing a computer to function as:
an information reception part that receives, from a supplier terminal of a supplier who owns an electric power device capable of performing an electric power supply, electric power supply data which includes available information representing an available electric power amount and a position of the electric power device;
an information transmission part that transmits the electric power supply data to a consumer terminal of a consumer who desires an electric power supply; and
a request reception part that receives a request of an electric power supply according to the electric power supply data from the consumer terminal.
